(19) United States
(12) Patent Application Publication
(10) Pub. No.: US 2025/0006930 A1
(43) Pub. Date: Jan. 2, 2025

(54) SUBSTRATE MODIFICATION WITH CROSSLINKED BRANCHED POLYMER FOR USE IN BATTERIES

(71) Applicant: Battelle Memorial Institute, Richland, WA (US)

(72) Inventors: Hyung-Seok Lim, Richland, WA (US); Litao Yan, Richland, WA (US); Zimin Nie, Edmonds, WA (US); Guosheng Li, Richland, WA (US); Yongsoon Shin, Richland, WA (US); Wei Wang, West Richland, WA (US)

(73) Assignee: Battelle Memorial Institute, Richland, WA (US)

(21) Appl. No.: 18/505,959

(22) Filed: Nov. 9, 2023

Related U.S. Application Data
(60) Provisional application No. 63/424,732, filed on Nov. 11, 2022.

(51) Int. Cl. H01M 4/60; H01M 4/04; H01M 4/66; H01M 8/18

(52) U.S. Cl. CPC H01M 4/604; H01M 4/0404; H01M 4/663; H01M 8/188

(57) ABSTRACT

A modified electrode includes a conductive substrate and a crosslinked branched polymer disposed on at least a portion of a surface of the conductive substrate. The crosslinked branched polymer comprises a plurality of tertiary amino groups and a plurality of carboxylic acid groups, carbonyl groups, hydroxyl groups, or any combination thereof. The electrode is useful in a battery, such as a redox flow battery.

### CROSS REFERENCE TO RELATED APPLICATION

This application claims the benefit of the earlier filing date of U.S. Provisional Application No. 63/424,732, filed Nov. 11, 2022, which is incorporated by reference herein in its entirety.

### ACKNOWLEDGMENT OF GOVERNMENT SUPPORT

This invention was made with government support under Contract DE-AC0576RL01830 awarded by the U.S. Department of Energy. The Government has certain rights in the invention.

### FIELD

This disclosure concerns electrodes comprising substrates modified with a crosslinked branched polymer.

### SUMMARY

Aspects of an electrode as disclosed herein include a conductive substrate and a crosslinked branched polymer disposed on at least a portion of a surface of the conductive substrate. The crosslinked branched polymer comprises a plurality of tertiary amino groups and a plurality of carboxylic acid groups, carbonyl groups, hydroxyl groups, or any combination thereof. Methods of making and using the electrode also are disclosed.

In any of the foregoing or following aspects, the conductive substrate may comprise carbon felt, carbon paper or carbon cloth. In some implementations, the crosslinked branched polymer coats individual carbon fibers on a surface of the conductive substrate.

In any of the foregoing or following aspects, the crosslinked branched polymer may comprise a branched polyalkylene imine polymer crosslinked with a crosslinker comprising at least two oxygen-containing reactive groups, where the at least two oxygen-containing reactive groups are C(O) groups, epoxy groups, —COOH groups, or any combination thereof. Exemplary polymers include, but are not limited to, branched polyethyleneimine, branched polypropyleneimine, branched poly(ethyleneimine-co-propyleneimine), or any combination thereof.

In any of the foregoing or following aspects, the crosslinker may comprise glutaraldehyde, glyoxal, malonaldehyde, succinaldehyde, adipaldehyde, methylglyoxal, glyoxal, biacetyl, cyclopentan-1,2-dione, oxalic acid, tartaric acid, citric acid, malic acid, succinic acid, 1,4-butanediol diglycidyl ether, ethylene glycol diglycidyl ether, poly(ethylene glycol) diglycidyl ether, glycerol dimethacrylate, glycerol dimethacrylate, poly(ethylene glycol) dimethacrylate, ethylene glycol dimethacrylate, 2-hydroxylethyl methacrylate, vinyl methacrylate, allyl methacrylate, 1,4-phenylene dimethacrylate, 1,4-butanediol dimethacrylate, carboxybetaine dimethacrylate, poly(carboxybetaine methacrylate), propylene dimethacrylate, poly(propylene glycol) dimethacrylate, or any combination thereof. In some implementations, the crosslinker comprises glutaraldehyde.

In some aspects, a battery includes (i) a first electrode comprising a conductive substrate and a crosslinked branched polymer disposed on at least a portion of a surface of the conductive substrate, the crosslinked branched polymer comprising a plurality of tertiary amino groups and a plurality of carboxylic acid groups; (ii) a second electrode; (iii) an electrolyte; and (iv) a membrane between the first electrode and the second electrode, wherein the crosslinked branched polymer on the surface of the conductive substrate is between the conductive substrate and the membrane. In certain aspects, the conductive substrate comprises carbon felt, and the crosslinked branched polymer comprises branched polyethyleneimine crosslinked with glutaraldehyde. The battery may be a redox flow battery. In certain implementations, the second electrode also comprises a conductive substrate and a crosslinked branched polymer disposed on at least a portion of a surface of the conductive substrate, the crosslinked branched polymer comprising a plurality of tertiary amino groups and a plurality of carboxylic acid groups.

The foregoing and other objects, features, and advantages of the invention will become more apparent from the following detailed description, which proceeds with reference to the accompanying figures.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1A-1C are a cross-sectional schematic diagram of a carbon fiber with a crosslinked branched polymer on a surface of the carbon fiber (FIG. 1A), a schematic diagram of a network of carbon fibers with the crosslinked branched polymer on the surface (FIG. 1B), and a schematic diagram of an exemplary redox flow battery including an electrode comprising a carbon fiber substrate with a crosslinked branched polymer on a surface of the carbon fiber (FIG. 1C).

FIG. 2 is a synthesis scheme for an exemplary crosslinked branched polymer as disclosed herein.

FIGS. 3A and 3B are schematic diagrams of a conventional vanadium redox flow battery system (FIG. 3A) and a vanadium redox flow battery system comprising an exemplary modified electrode as disclosed herein (FIG. 3B).

FIG. 4 shows Fourier transform infrared (FTIR) spectra of a graphitic carbon fiber (GCF) baseline electrode (lower spectrum) and a GCF electrode modified with crosslinked polyethyleneimine with amino and carboxylic acid groups (PEIAA-GCF) (upper spectrum).

FIGS. 5A-5H are scanning electron microscopy (SEM) images of pristine GCF (FIGS. 5A, 5B) and PEIAA-GCF (FIGS. 5C, 5D) electrodes under 1,000× and 10,000× magnifications, an SEM-EDX spectrum of the PEIAA-GCF (FIG. 5E); and carbon (FIG. 5F), oxygen (FIG. 5G), and nitrogen (FIG. 5H) element maps of the PEIAA-GCF.

FIGS. 6A-6F are SEM images of pristine GCF (FIG. 6A), PEIAA-GCF (FIG. 6B); an SEM-EDX spectrum of the pristine GCF (FIG. 6C); and carbon (FIG. 6D), oxygen (FIG. 6E), and nitrogen (FIG. 6F) element maps of the pristine GCF.

FIGS. 7A and 7B are photographs showing water drop contact angles with the pristine GCF (FIG. 7A) and PEIAA-GCF (FIG. 7B).

FIG. 8 is a graph showing thermogravimetric curves of pristine GCF (a) and PEIAA-GCF (b), performed in nitrogen gas.

FIG. 9 is a graph showing Barrett-Joyner Halenda adsorption pore sire distribution based on the adsorption isotherm of pristine GCF (a) and PEIAA-GCF (b).

FIG. 10 is photographs showing that PEIAA swells after immersion in 0.9 M H₂SO₄ for 5 hours.

FIGS. 11A and 11B are digital photographs of PEIAA colloidal solutions prepared with deionized water and 0.9 M H₂SO₄ (FIG. 11A) and a bar graph of the zeta potentials (FIG. 11B).

FIGS. 12A and 12B show the discharge capacity (open squares), Coulombic efficiency (solid circles), and energy efficiency (open circles) of cells with pristine GCF (a) and PEIAA-GCF (b) electrodes (FIG. 12A); and voltage-time profiles of the 1^{st}, 50^{th}, and 100^{th} cycles of the cells under constant current charge at 50 mA cm⁻² (FIG. 12B).

FIG. 13 shows cyclic voltammetry curves of pristine and PEIAA-GCF electrodes under 0.5 mv s⁻¹ and 2.5 mV s⁻¹ scan rates in 1.5 M VOSO₄ in 3.5 M H₂SO₄.

FIGS. 14A and 14B show EIS spectra of vanadium redox flow cells with pristine GCF (FIG. 14A) and PEIAA-GCF (FIG. 14B) electrodes and the equivalent circuit. R_{b}—bulk resistance of the cell, R_{sf}—resistance and capacitance of the interfacial layer, R_{ct}—charge transfer resistance, W—diffusional effect of vanadium ions on the electrode.

FIG. 15 shows UV-VIS spectra of the 3.5 M sulfuric acid solutions with pristine GCF (a) or PEIAA-GCF (b) electrode after 5 days with a flow rate of 30 mL min⁻¹.

FIG. 16 shows SEM images of a fresh PEIAA-GCF positive electrode before and after 100 cycles at a current density of 50 mA cm⁻².

FIGS. 17A-17E are an SEM image (FIG. 17A) and SEM EDX maps (carbon-FIG. 17B, oxygen-FIG. 17C, vanadium-FIG. 17D, and nitrogen-FIG. 17E) of part of a PEIAA-GCF positive electrode after 100 cycles at a current density of 50 mA cm⁻².

FIGS. 18A-18D show wide scan x-ray photoelectron spectroscopy (XPS) and inserted N 1s spectra of PEIAA GCF electrode before (FIG. 18A) and after (FIG. 18B) after 100 cycles at a constant current charge of 50 mA cm⁻², as well as high-resolution XPS C 1s spectra of pristine (FIG. 18C) and PEIAA-GCF (FIG. 18D) electrodes before and after 100 cycles.

FIGS. 19A and 19B are wide scan XPS spectra of pristine GCF electrode before (FIG. 19A) and after (FIG. 19B) 100 cycles at a constant current charge of 50 mA cm⁻².

FIGS. 20A and 20B are SEM images of Nation® 115 membranes in the GCF baseline (FIG. 20A) and PEIAA-GCF (FIG. 20B) cells after 100 cycles.

FIGS. 21A and 21B are SEM images of a fresh pristine GCF electrode (FIG. 21A) and the electrode after 100 cycles (FIG. 21B) at a current density of 50 mA cm⁻².

FIG. 22 shows 1H NMR spectra of catholytes in pristine GCF and PEIAA-GCF cells before and after 100 cycles at a current density of 50 mA cm⁻².

### DETAILED DESCRIPTION

Aspects of a modified electrode for use in batteries, such as redox flow batteries, are disclosed. The modified electrode includes a conductive substrate and a crosslinked branched polymer disposed on at least a portion of a surface of the conductive substrate, the crosslinked branched polymer comprising a plurality of tertiary amino groups and a plurality of carboxylic acid groups, carbonyl groups, hydroxyl groups, or any combination thereof. The crosslinked branched polymer forms a gel polymer interface (GPI) between the conductive substrate and a separator membrane in the battery. Advantageously, at least some aspects of the disclosed electrode mitigate capacity decay of batteries and exhibit excellent electrochemical performance.

### I. Definitions and Abbreviations

The following explanations of terms and abbreviations are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the following detailed description and the claims.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person of ordinary skill in the art to have a more definitive construction, the numerical parameters set forth are approximations that may depend on the desired properties sought and/or limits of detection under standard test conditions/methods as known to those of ordinary skill in the art. When directly and explicitly distinguishing embodiments from discussed prior art, the embodiment numbers are not approximates unless the word “about” is recited.

Although there are alternatives for various components, parameters, operating conditions, etc. set forth herein, that does not mean that those alternatives are necessarily equivalent and/or perform equally well. Nor does it mean that the alternatives are listed in a preferred order unless stated otherwise.

Definitions of common terms in chemistry may be found in Richard J. Lewis, Sr. (ed.), Hawley's Condensed Chemical Dictionary, published by John Wiley & Sons, Inc., 2016 (ISBN 978-1-118-13515-0).

In order to facilitate review of the various embodiments of the disclosure, the following explanations of specific terms are provided:

Anode: An electrode through which electric charge flows into a polarized electrical device. From an electrochemical point of view, negatively-charged anions move toward the anode and/or positively-charged cations move away from it to balance the electrons leaving via external circuitry.

Cathode: An electrode through which electric charge flows out of a polarized electrical device. From an electrochemical point of view, positively charged cations invariably move toward the cathode and/or negatively charged anions move away from it to balance the electrons arriving from external circuitry.

Cell: As used herein, a cell refers to an electrochemical device used for generating a voltage or current from a chemical reaction, or the reverse in which a chemical reaction is induced by a current. Examples include voltaic cells, electrolytic cells, redox flow cells, and fuel cells, among others. A battery includes one or more cells, or even one or more stacks. The terms “cell” and “battery” are used interchangeably when referring to a battery containing only one cell.

Electrode: An electrical conductor used to make contact with a nonmetallic part of a circuit.

Electrolyte: A substance containing free ions that behaves as an ionically conductive medium. In a redox flow battery, some of the free ions are electrochemically active elements. An electrolyte in contact with the anode, or negative half-cell, may be referred to as an anolyte, and an electrolyte in contact with the cathode, or positive half-cell, may be referred to as a catholyte. With respect to vanadium sulfate acid redox flow battery systems, the electrolyte conventionally refers to vanadium species in an aqueous sulfuric acid solution. As used herein, the terms “anolyte” and “catholyte” refer to vanadium species in an aqueous “supporting solution.” The supporting solution, or supporting electrolyte, is an aqueous solution comprising sulfate ions, chloride ions, phosphate ions, protons, and other counterions introduced through added components that are not redox active. The anolyte and catholyte are often referred to as the negative electrolyte and positive electrolyte, respectively, and these terms can be used interchangeably.

Gel: A colloidal system comprising a solid three-dimensional network within a liquid. By weight, a gel is primarily liquid, but behaves like a solid due to a three-dimensional network of entangled and/or crosslinked molecules of a solid within the liquid.

Gel polymer interface (GPI): As used herein, the term “gel polymer interface” refers to a polymeric gel between a conductive substrate of an electrode and a membrane separator in a cell. The GPI may be disposed on at least a portion of a surface of the conductive substrate.

Graphitic carbon fiber: Carbon fiber in which the carbon atoms have an ordered crystalline structure. In contrast to amorphous carbon, stacked layer planes of graphitic carbon have a fixed three-dimensional order.

Half-cell: An electrochemical cell includes two half-cells. Each half-cell comprises an electrode and an electrolyte. A redox flow battery has a positive half-cell in which ions are oxidized, and a negative half-cell in which ions are reduced during charge. Opposite reactions happen during discharge. In an all vanadium redox flow battery, VO²⁺ ions in the positive half-cell are oxidized to VO₂⁺ ions (V⁴⁺ oxidized to V⁵⁺), and V³⁺ ions in the negative half-cell are reduced to V²⁺ ions during charge.

Polymer: A molecule of repeating structural units (e.g., monomers) formed via a chemical reaction, i.e., polymerization.

### II. Electrodes and Battery Systems

Redox flow batteries (RFBs) can provide electrical energy converted from chemical energy continuously, and are promising systems for energy storage to integrate renewable energies (e.g., solar and/or wind energy) into electrical supply grids. A RFB system comprises a positive half-cell and a negative half-cell. The half-cells are separated by a membrane or separator, such as an ion-conductive membrane or separator. The positive half-cell contains a catholyte and the negative half-cell contains an anolyte. The anolyte and catholyte are solutions comprising electrochemically active elements in different oxidation states. The electrochemically active elements in the catholyte and anolyte couple as redox pairs. During use, the catholyte and anolyte are continuously circulating through the positive and negative electrodes, respectively, where the redox reactions proceed providing the conversion between chemical energy and electrical energy or vice-versa. To complete the circuit during use, positive and negative electrodes of a RFB are electrically connected through current collectors with an external load. However, capacity decay caused by crossover of active materials is a universal challenge for many flow battery systems, which are based on various chemistries. Additionally, vanadium 4+ species may be oxidized continuously in the catholyte during cycling, contributing to the severe capacity decay.

This disclosure concerns aspects of a modified electrode comprising a conductive substrate, and a crosslinked branched polymer disposed on at least a portion of a surface of the conductive substrate. The crosslinked branched polymer comprises a plurality of tertiary amino groups and a plurality of carboxylic acid groups, carbonyl groups, hydroxyl groups, or any combination thereof. The crosslinked branch polymer is hydrophilic, and forms a gel polymer interface (GPI) when immersed in an electrolyte. In some aspects, when placed in a battery, the GPI is between the conductive substrate of the positive electrode and a membrane separator of the battery. In certain aspects, the GPI is also introduced between the conductive substrate of the negative electrode and the membrane. The GPI functions as a key component to prevent ions, such as vanadium ions, from crossing the membrane, thus supporting stable long-term cycling.

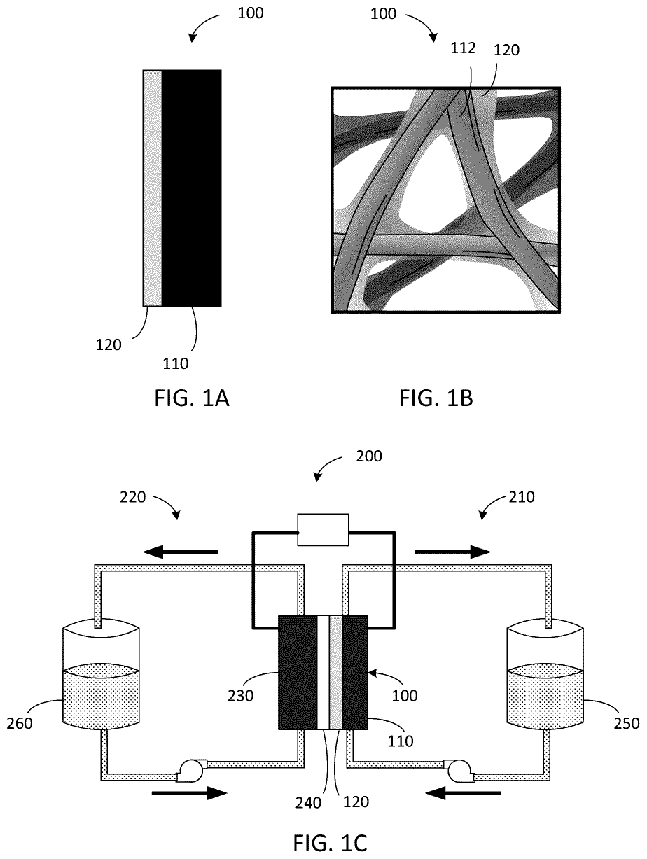

FIG. 1A is a schematic diagram of an exemplary electrode 100 comprising a conductive substrate 110 and a crosslinked branched polymer 120 disposed on a surface of the conductive substrate 110. FIG. 1B is an expanded view of the electrode 100 where the conductive substrate 110 comprises carbon fibers 112 (e.g., carbon felt, carbon paper, or carbon cloth). The carbon fiber 112 may be graphitic carbon fiber (GCF). In FIG. 1B, the crosslinked branched polymer 120 is disposed on carbon fibers 112 on at least the surface of the conductive substrate 110. As shown in FIG. 1B, the crosslinked branched polymer 120 coats individual carbon fibers 112, rather than forming a continuous coating across the entire surface of the conductive substrate 110.

In any of the foregoing or following aspects, the crosslinked branched polymer may comprise a branched polyalkylene imine polymer crosslinked with a crosslinker comprising at least two oxygen-containing reactive groups, where the at least two oxygen-containing reactive groups are C(O) groups, epoxy groups, —COOH groups, or any combination thereof. In some aspects, the branched polyalkylene imine polymer comprises branched polyethyleneimine, branched polypropyleneimine, or branched poly(ethyleneimine-co-propyleneimine), or any combination thereof. In some aspects, the branched polyalkylene imine polymer has a weight average molecular weight M_{w} of 20 kDa to 30 kDa by light scattering, a number average molecular weight Mₙ of 8 kDa to 12 kDa by gel permeation chromatography, or both. In certain implementations, the branched polyalkylene imine polymer comprises branched polyethyleneimine.

In any of the foregoing or following aspects, the crosslinker may be a dicarbonyl compound (e.g., a dialdehyde, a diketone, an aldehyde-ketone), a dicarboxylic acid compound, a diglycidyl ether compound, a diacrylate compound or any combination thereof. Exemplary crosslinkers include, but are not limited to, glutaraldehyde, glyoxal, malonaldehyde, succinaldehyde, adipaldehyde, methylglyoxal, glyoxal, biacetyl, cyclopentan-1,2-dione, oxalic acid, tartaric acid, citric acid, malic acid, succinic acid, 1,4-butanediol diglycidyl ether, ethylene glycol diglycidyl ether, poly(ethylene glycol) diglycidyl ether, glycerol dimethacrylate, glycerol dimethacrylate, poly(ethylene glycol) dimethacrylate, ethylene glycol dimethacrylate, 2-hydroxylethyl methacrylate, vinyl methacrylate, allyl methacrylate, 1,4-phenylene dimethacrylate, 1,4-butanediol dimethacrylate, carboxybetaine dimethacrylate, poly(carboxybetaine methacrylate), propylene dimethacrylate, poly(propylene glycol) dimethacrylate, or any combination thereof. In some implementations, the crosslinker is glutaraldehyde.

In any of the foregoing or following aspects, the crosslinked branched polymer may comprise the crosslinker and the branched polyalkylene imine polymer in a molar ratio of from 20:1 to 125:1, such as a molar ratio from 25:1 to 100:1. In some implementations, the crosslinked polymer comprises the branched polyalkylene imine polymer and the glutaraldehyde in a weight ratio of from 3:1 to 7:1. The branched polyalkylene imine polymer in such implementations may have a weight average molecular weight M_{w} of 20 kDa to 30 kDa by light scattering, a number average molecular weight Mₙ of 8 kDa to 12 kDa by gel permeation chromatography, or both.

In any of the foregoing or following aspects, the crosslinked branched polymer may be disposed on 10% to 30% of a surface area of the conductive substrate, such as from 15% to 25% of the surface area. In some aspects, the polymer is disposed on 10% to 30% of all surface areas of the conductive substrate. In other aspects, the polymer is disposed on 10% to 30%, or 15% to 25%, of the surface area of a surface of the conductive substrate that faces toward the membrane in the redox flow battery.

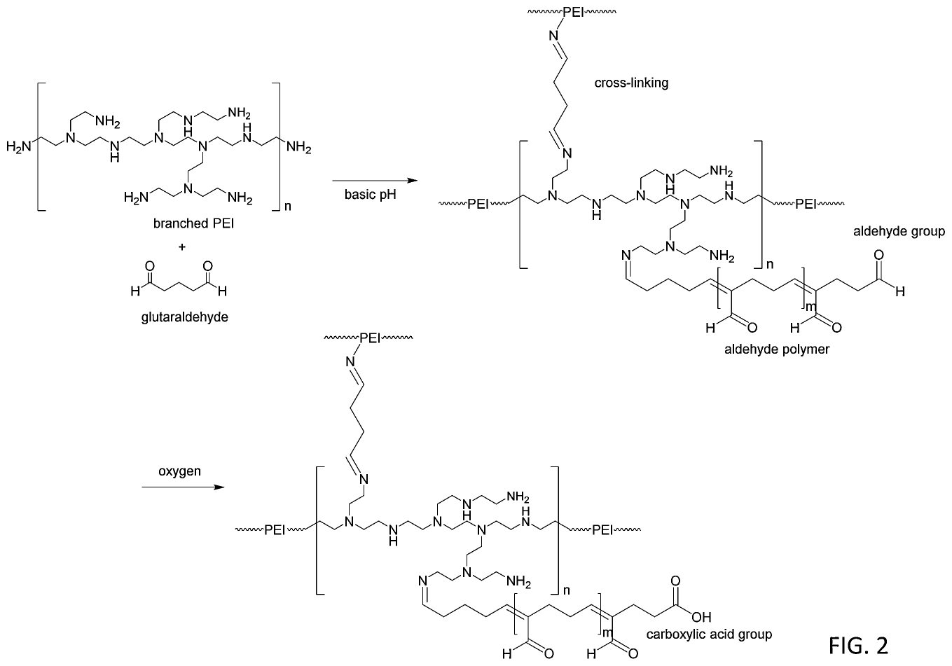

In any of the foregoing or following aspects, the crosslinked branched polymer may comprise glutaraldehyde-crosslinked polyethyleneimine. An exemplary synthesis scheme and chemical structure of glutaraldehyde-crosslinked polyethyleneimine is shown in FIG. 2. In some aspects, the polyethyleneimine has a weight average molecular weight M_{w} of 20 kDa to 30 kDa by light scattering, a number average molecular weight Mₙ of 8 kDa to 12 kDa by gel permeation chromatography, or both. In certain aspects, the crosslinked branched polymer comprises the polyethyleneimine polymer and the glutaraldehyde in a weight ratio of from 3:1 to 7:1. In some implementations, the glutaraldehyde-crosslinked polyethyleneimine is disposed on 10% to 30% of a surface area of the conductive substrate. In certain implementations, the conductive substrate comprises carbon fibers, such as graphitic carbon fibers.

Aspects of a battery comprise (i) a first electrode comprising a conductive substrate and a crosslinked branched polymer disposed on a surface of the conductive substrate, the crosslinked branched polymer comprising a plurality of tertiary amino groups and a plurality of carboxylic acid groups; (ii) a second electrode; (iii) an electrolyte; and (iv) a membrane between the first electrode and the second electrode, wherein the crosslinked branched polymer on the surface of the conductive substrate is between the conductive substrate and the membrane. The crosslinked branched polymer has a swellable three-dimensionally crosslinked structure, which swells to form the GPI when immersed in an acidic solution, such as the electrolyte.

In some aspects, the battery is a redox flow battery. The redox flow battery may be a vanadium redox flow battery. FIG. 1C is a schematic diagram of an exemplary redox flow battery 200. The battery 200 comprises a cathode half cell 210 and an anode half cell 220. The battery 200 further comprises a first electrode 100 comprising a conductive substrate 110 and a crosslinked branched polymer 120 disposed on a surface of the conductive substrate 110, and a second electrode 230; the first electrode 100 is in the cathode half cell 210 and the second electrode 230 is in the anode half cell 220. The battery 200 further includes a membrane 240 between the first and second electrodes 100, 230, wherein the crosslinked branched polymer 120 is between the membrane 240 and the conductive substrate 110 of the first electrode 100. During operation, the battery 200 also comprises an electrolyte system comprising a catholyte 250 and an anolyte 260. In some aspects (not shown), the second electrode 230 also comprises a conductive substrate and a disclosed crosslinked branched polymer disposed on a surface of the conductive substrate, where the crosslinked branched polymer is between the conductive substrate and the membrane. In some implementations (not shown), the battery may further include current collectors and/or conductive plates in contact with the electrodes, as will be understood by a person of ordinary skill in the art of batteries. When the electrode comprises a conductive substrate and a crosslinked branched polymer, the current collector or bipolar plate is not between the crosslinked branched polymer 120 and the membrane 240.

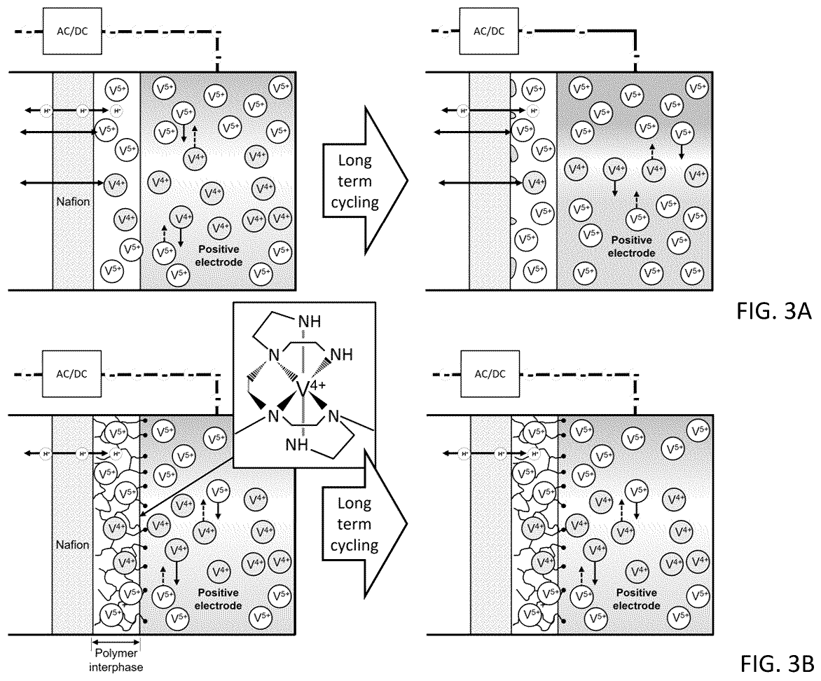

When using a conventional electrode without a GPI as disclosed herein, a cell may exhibit crossover through the separator membrane during prolonged cycling (see, e.g., FIG. 3A). For example, with respect to vanadium redox flow batteries (VRBs), mechanistic studies suggest that the main reasons for capacity decay in a VRB during cycling are imbalanced crossover of vanadium active species and asymmetrical valence of vanadium ions in the electrolytes caused by self-discharge reactions after crossover (Luo et al., ChemSusChem 2013, 6 (2): 268-274.) In particular, there is an asymmetric valence of redox active species in the anolyte (V³⁺) and decreasing VO²⁺ in the catholyte. The imbalanced accumulation of VO₂⁺ in the positive side contributes to capacity fading. As a result, the amount of redox-active species VO²⁺ (V⁴⁺) in the positive side becomes significantly reduced and replaced with a high concentration of VO₂⁺ (V⁵⁺) indicating the reaction becomes irreversible because of crossover of vanadium ions by possible diffusion, migration, electro-osmotic convection, and side reactions in both electrolytes. Another issue is precipitation of vanadium compounds on the membrane, which may block membrane pores, decrease proton conductivity, and further increase cell polarization. Although new membranes have been developed to mitigate these problems, the complicated fabrication or modification processes may result in high cost. The cationic-charged polymer films or surface coating on a membrane acting as an electrical repulsion barrier also disturbs proton permeation, thus leading to higher area resistance (Luo et al., J of Membrane Science 2008, 311 (1) (: 98-103). Thus, capacity decay remains a key challenge.

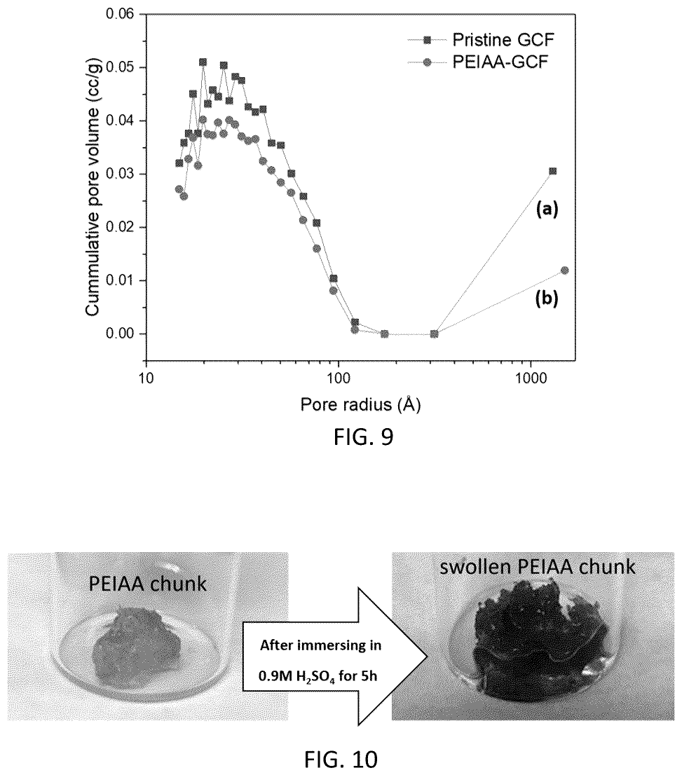

Aspects of the disclosed electrodes modified with a GPI comprising a crosslinked branched polymer as disclosed herein exhibit advantages and mitigate the foregoing problems. For example, the GPI may effectively reduce or prevent active species crossover, as shown in FIG. 3B, thereby maintaining balanced active species in the electrolytes. Without wishing to be bound by a particular theory, active species crossover may be reduced through mechanisms of electrical repulsion from protonated amines in acidic condition, physical hindrance from swollen crosslinked branched polymer to limit crossover, and improved wettability of the conductive substrate. Additionally, possible coordination chemistry from amine (e.g., tertiary amine) and carboxylic acid functional groups on the crosslinked branched polymer may stabilize the oxidation states of active species, such as the VO₂₊ and VO₂⁺ species. Specifically, tertiary amines on the crosslinked branched polymer can coordinate with vanadium ions, reducing the amount of V⁴⁺ oxidation. Tertiary and ionized amino groups also can coordinate sulfate anions. In some examples, the concentration of VO²⁺ was virtually unchanged in the catholyte, with >99.4% remaining after 100 cycles. The GPI also may increase surface wettability of the conductive substrate due its hydrophilicity. In some aspects, crosslinked branched PEI with amino and carboxylic acid groups (PEIAA) in acidic conditions acts to not only repulse vanadium ions with extended polymer networks but to consequently stabilize the oxidation state of vanadium ions with positively charged amines (FIG. 3B). In some examples, redox flow battery including an electrode comprising the PEIAA GPI with abundant amounts of primary, secondary, and tertiary amines and also oxygen-containing groups that are mainly carboxylic acid groups preserved almost the same concentration of negative and positive electrolytes even after 100 cycles. In a working example, the PEI GPI resulted in five times higher cycling stability in capacity retention with higher Coulombic efficiency than a pristine graphitic carbon felt (GCF) cell. Another advantage is a reduction or elimination of vanadium compound precipitation on the membrane (see, e.g., FIGS. 9A and 9B), compared to a conventional electrode without the GPI. In cells with conventional electrodes, precipitation of vanadium compounds, e.g., vanadium (V) sulfate and/or vanadium (IV) oxide sulfate, arises a high states of charge. In contrast, cells that include an electrode and GPI as disclosed herein exhibit reduced precipitation, which keeps the internal resistance more stable than the internal resistance of cells that do not include the GPI.

### III. Method of Making

In some aspects, a method of making an electrode as disclosed herein includes (i) immersing a portion of a conductive substrate in a solution comprising a branched polymer comprising a plurality of tertiary amino groups, and (ii) subsequently immersing the portion of the conductive substrate in a solution comprising a crosslinker comprising at least two oxygen-containing reactive groups, where the at least two oxygen-containing reactive groups are C(O) groups, epoxy groups, —COOH groups, or any combination thereof, whereby the crosslinker crosslinks the branched polymer to provide a crosslinked branched polymer on a surface of the portion of the conductive substrate (see, e.g., FIG. 1B for a diagram of the polymer-coated conductive substrate and FIG. 2 for an exemplary crosslinking reaction). In some implementations, the solution comprising the branched polymer and the solution comprising the crosslinker have a basic pH (pH>7). The basic pH may result from the chemical nature of the branched polymer and/or the crosslinker.

If the crosslinker retains one or more C(O) or epoxy groups after crosslinking the branched polymer, the method may further include subsequently heating the crosslinked branched polymer on the surface of the portion of the conductive substrate to convert at least some of the one or more C(O) or epoxy groups of the crosslinker to carboxylic acid groups (e.g., as shown in FIG. 2). In some aspects, heating the crosslinked branched polymer comprises heating at a temperature of at least 70° C. for at least 3 hours under vacuum or heating at a temperature of at least 70° C. for at least 10 hours in an oxygen-containing atmosphere. Heating under a vacuum may be performed when the crosslinker comprises carboxylic acid groups. Heating in an oxygen-containing atmosphere is performed when the crosslinker comprises oxidizable groups, such as aldehyde groups, carbonyl groups (ketones), and/or epoxy groups.

In any of the foregoing or following aspects, immersing a portion of the conductive substrate into the solution comprising the branched polymer may comprise immersing 10% to 30%, such as 15% to 25% of a surface area of the conductive substrate into the solution comprising the branched polymer. In any of the foregoing or following aspects, immersing a portion of the conductive substrate into the solution comprising the crosslinker may comprise immersing 10% to 30%, such as 15% to 25%, of a surface area of the conductive substrate into the solution comprising the crosslinker. In one aspect, the steps of immersing the portion of the conductive substrate into the solution comprising the branched polymer and the solution comprising the crosslinker are performed in the reverse order. In certain aspects, the steps of immersing the portion of the conductive substrate into the solution comprising the branched polymer and the solution comprising the crosslinker are repeated sequentially one or two times. In some implementations, a crosslinking reaction spontaneously occurs after the portion of the conductive substrate has been immersed into each of the solutions (FIG. 2).

In any of the foregoing or following aspects, the conductive substrate may comprise carbon fibers. In some aspects, the carbon fibers are graphitic carbon fibers. In certain implementations, the conductive substrate comprises graphitic carbon fibers in the form of carbon felt, carbon paper, or carbon cloth.

In any of the foregoing or following aspects, the branched polymer may comprise a polyalkylene imine and the crosslinker may comprise a dicarbonyl compound (e.g., a dialdehyde, a diketone, an aldehyde-ketone), a dicarboxylic acid compound, a diglycidyl ether compound, a diacrylate compound or any combination thereof. In some aspects, the crosslinker comprises a dialdehyde. In certain aspects, the crosslinker comprises glutaraldehyde. In some implementations, the branched polymer comprises a branched polyalkylene imine, such as branched polyethyleneimine, branched polypropyleneimine, branched poly(ethyleneimine-co-propyleneimine), or any combination thereof. In any of the foregoing or following aspects, the branched polyalkylene imine polymer may have a weight average molecular weight M_{w} of 20 kDa to 30 kDa by light scattering, a number average molecular weight Mₙ of 8 kDa to 12 kDa by gel permeation chromatography, or both. In certain implementations, the branched polymer comprises polyethyleneimine and the crosslinker comprises glutaraldehyde.

In any of the foregoing or following aspects, the crosslinker solution and branched polymer solutions may have concentrations providing a molar ratio of crosslinker to branched polymer of from 20:1 to 125:1, such as a molar ratio from 25:1 to 100:1. In some aspects, the crosslinked polymer comprises a branched polyalkylene imine polymer, the crosslinker comprises glutaraldehyde, and the branched polymer solution and glutaraldehyde solutions may have concentrations providing a polymer to glutaraldehyde weight ratio of from 3:1 to 7:1. The branched polyalkylene imine polymer in such implementations may have a weight average molecular weight M_{w} of 20 kDa to 30 kDa by light scattering, a number average molecular weight Mₙ of 8 kDa to 12 kDa by gel permeation chromatography, or both.

### IV. Examples

### Materials

Vanadium (IV) oxide sulfate (VOSO₄·xH2O, 99.5%, pure, crystal was purchased from Noah Technologies. The membrane (Nafion™ 115) was purchased from DuPont (Wilmington, DE) and pre-treated in de-ionized (DI) water before use. Nafion™ membranes are perfluorinated cationic exchange membranes with a tetrafluoroethylene backbone and sulfonate vinyl ether groups. The graphitic carbon felt (GCF) (4 mm thick), and gasket (EPDM rubber sheet, 1/32 in. thick) were purchased from the FuelCellStore. The polyethyleneimine (PEI) (branched, average M_{w}˜25,000 daltons) and glutaraldehyde (GA) (50% in H₂O) were purchased at Sigma-Aldrich.

PEIAA (polyethyleneimine with amino and carboxylic acids) modification on GCF electrodes: The crosslinked PEIAA was introduced to the surface of the GCF by sequential immersion in two different deionized (DI) waters containing hyper-branched PEI (25,000 M_{w}) and GA (50% in solution), respectively. To get carboxylic acid groups in the PEI backbone, GA (1 wt %) was used. In this step, only one-fifth of a pristine GCF electrode (5*6 cm²) was immersed in each solution one-by-one two times. The samples were stored at 70° C. for 12 hours in an oven or for 5 hours under vacuum. During this time, the samples dried and the aldehyde groups oxidized to carboxylic acid groups on the polymer backbone. Then the samples were washed in DI water several times to remove residual molecules and dried overnight. The dried PEIAA-GCF was cut into two pieces (2*5 cm²) for use as electrodes. FIGS. 1A and 1B are schematic illustrations of a PEIAA-GCF samples.

Swelling behavior and zeta potential measurement: The PEI polymeric solution was mixed with GA solution in a weight ratio of 10:1. After it was washed and dried using the same procedures used for the PEIAA modification on GCF, a PEIAA sample was prepared to observe its swelling behavior in acidic conditions. The PEIAA sample was fully immersed in 3.5M H₂SO₄ solution for 5 hours. To investigate the electrostatic force of PEIAA in acidic condition, a zeta potential measurement was conducted by Malvern Zetasizer® Nano ZS (Malvern Panalytical, Malvern, UK) with the Smoluchowski model. While the diluted PEI solution (0.5 wt %) with 200 mL of DI water was stirred at 800 rpm in a round bottom flask using a magnetic spin bar, the diluted GA solution (1 wt %) with 100 ml of DI water was slowly added over a 2-hour period using a dropping funnel. To remove the entangled particles, we used centrifugation at 3000 rpm. After drying and washing using the same procedure described previously, the PEIAA particles were dispersed in DI water and 0.9M H₂SO₄ solution by ultra sonication for 1 hour. The colloidal solutions were directly used for the zeta potential measurement.

Electrochemical measurement: The cyclic voltammetry (CV) was carried out in 1.5M VOSO₄ in 3.5M H₂SO₄ catholyte from 0.4 to 1.7V at 25° C. The pristine GCF and PEIAA-GCF samples were used as working electrodes attached with graphite electrode. The effective area of CF electrodes exposed to the catholyte is 6 mm×6 mm. The glassy carbon and Ag/AgCl were used as the counter and reference electrode, respectively. The three electrodes system was purged with N₂ gas for 10 min before the CV test. Electrochemical impedance spectroscopy (EIS) test was also operated over the frequency range of 0.1 Hz to 100 KHz with an amplitude of 5 mV.

Ultraviolet-visible (UV-vis) spectroscopy analysis: The concentration of V⁴⁺ in the 3.5M H₂SO₄ solutions was analyzed using a UV-vis spectrophotometer (UXL-360, HI2608) by monitoring the maximum absorbance wavelength located at 765 nm (Choi et al., J Electrochem. Soc. 2013, 160 (6): A973-A979). First, a standard calibration analysis based on a series of known concentrations of V(IV)OSO₄ solutions ranging from 0.01 M to 0.2 M was performed. Then, the concentration of V⁴⁺ samples was determined by comparison with a standard calibration curve.

Redox-flow battery test: Electrochemical performances of PEIAA-GCF and pristine GCF electrodes were tested in a homemade flow cell with a 10 cm² active area, which was controlled by an Arbin BT-2000® instrument (Arbin Instruments, College Station, TX) for galvanic charge/discharge cycles within a 0.8 V-1.6 V voltage range at a constant current density of 50 mA cm⁻². The flow rate of the electrolytes was 30 mL min⁻¹ (the pump was a Cole Parmer, easy-load 2, 77202-60). Vanadium 3+ and 4+ (VO²⁺) solutions were prepared and used as the anolyte and catholyte (1.5M VOSO₄ in 3.5M H₂SO₄), respectively. Nafion® N115 membranes were used for the cell test. Pristine GCF and PEIAA-GCF were used as the electrodes. Detailed descriptions of the cell design and testing procedures are described in previous publications (Li et al., ChemSusChem 2014, 7 (2): 577-584; Estevez et al., ChemSusChem 2016, 9 (12): 1455-1461; Vijayakumar et al., ACS Applied Materials & Interfaces 2016, 8 (50): 34327-34334; Li et al., Adv. Energy Mater. 2011, 1 (3): 394-400).

### Results and Discussion

The chemical reaction that yields the PEIAA is shown in FIG. 2, wherein m and n independently are integers greater than 1. GA had two roles in this study. Uncrosslinked (linear) PEI is not stable in aqueous solutions because thermodynamically compatible water molecules easily diffuse into the PEI phase and disentangle the polymer molecules. Thus, GA was used as a crosslinker to stabilize the PEI under strong acidic conditions (Abu-Dief et al., Benie Suef Univ. J of Basic and Applied Sciences 2015, 4 (2): 119-133) because it readily reacts with amine-containing molecules such as PEI through the formation of Schiff bases. Thus, a gel polymer interface (GPI) with a swellable three dimensionally crosslinked structure is obtained. GA molecules in aqueous solutions also form aldehyde polymers. In the drying step for the GCF samples treated in PEI and GA solutions at 70° C. in air, aldehydes are readily oxidized via the following reaction to form carboxylic acid groups:

2RCHO+O₂→2RCOOH

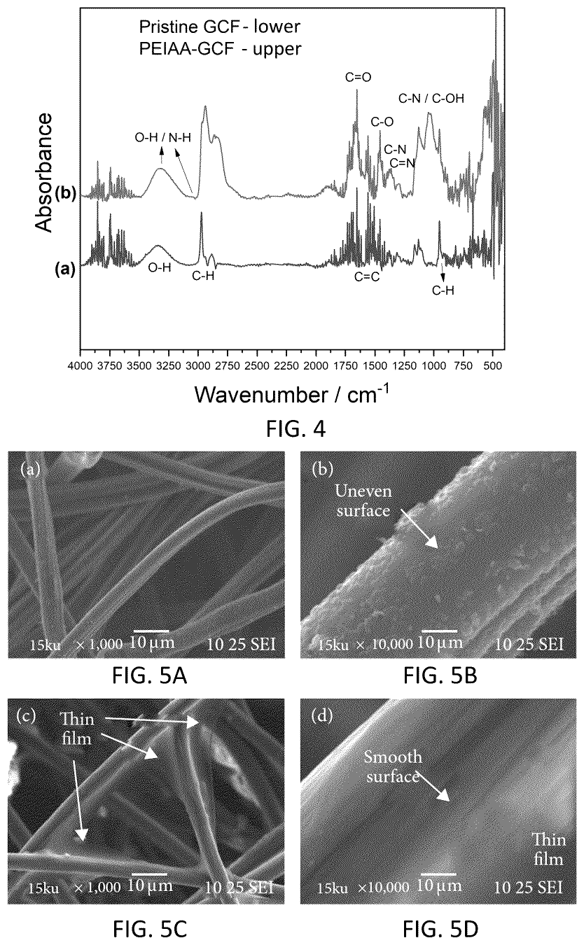

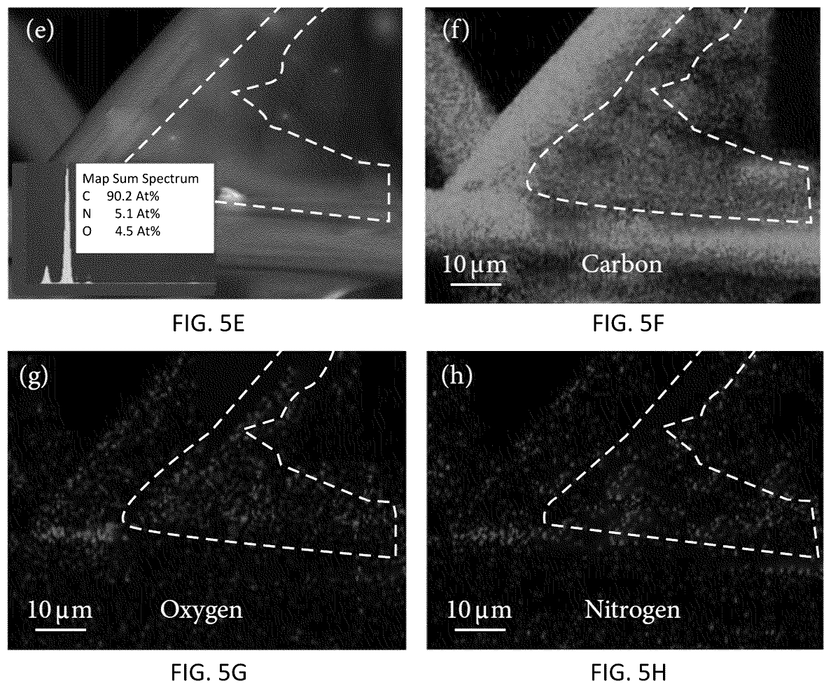

FTIR spectra of pristine GCF and PEIAA-GCF samples reveal that the PEIAA-GCF sample had amino and carboxylic acid groups (amines and carboxylic acids). In the case of the pristine GCF, FIG. 4 shows oxygen-containing groups in the PEIAA-GCF over a very broad band in the 3300-2500 cm⁻¹ region for hydroxyl(O—H) stretching, intense bands from 1760-1690 cm⁻¹ and 1320-1200 cm⁻¹ corresponding to C═O (polymeric aldehyde segment with carboxylic acids) (Marques et al., J. Appl. Polymer Sci. 2009, 112 (3): 1771-1779; Negrell et al., European Polymer J. 2018, 109:544-563), C—OH vibration comprised of a mixture of C—O stretch and C—O—H bend with the appearance of typical N—H and C—N stretching vibrations corresponding to amino groups and PEI backbone. Therefore, the amino and carboxylic acid groups were successfully introduced into PEI backbones. FIGS. 5A-5D show scanning electron microscopy (SEM) images of pristine GCF (5A, 5B) and PEIAA-GCF (5C, 5D) electrodes under different magnifications. The chemical reaction to form the PEIAA is shown in FIG. 2.

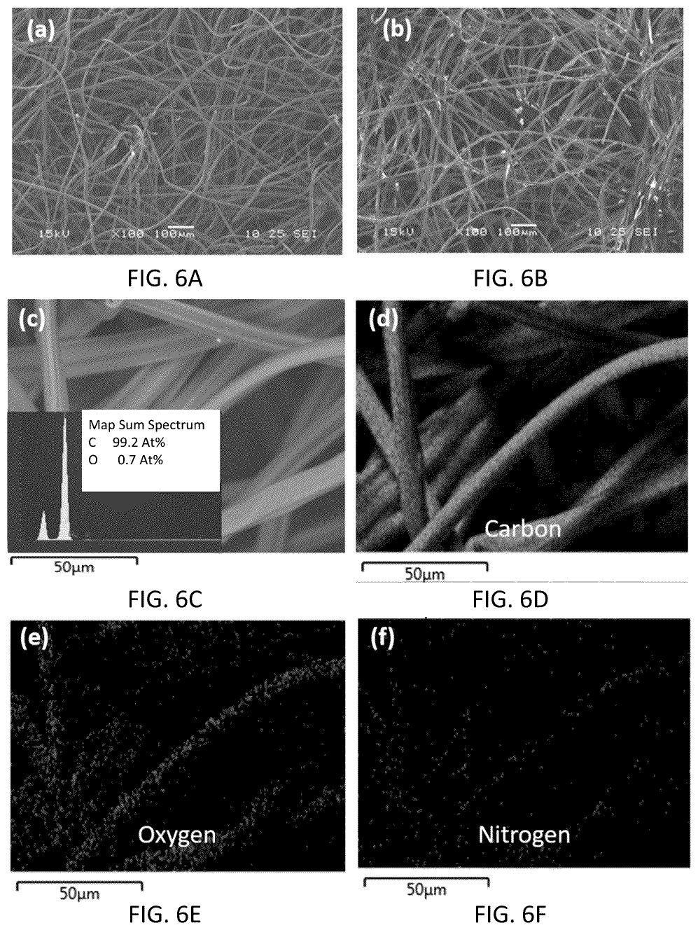

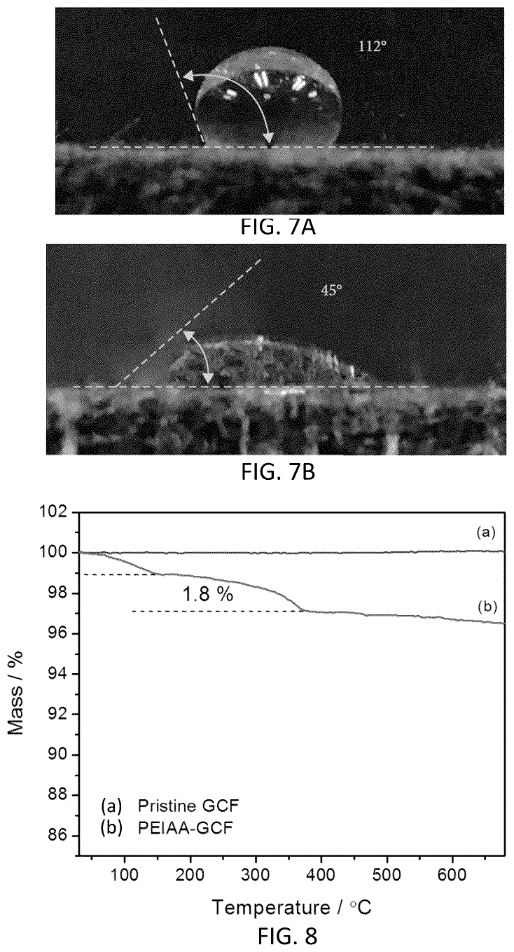

After PEIAA modification using the immersion method and followed by oxidation in air, the string surface of the PEIAA-GCF became smooth with very thin polymer films around the carbon strings. Rapid reaction of aldehydes and primary amines of PEI dissolved in aqueous solutions by formation of Schiff bases makes the polymers partially hydrophobic so they have an affinity for the hydrophobic surface of the carbon strings (Abu-Dief et al., Benie Suef Univ. J of Basic and Applied Sciences 2015, 4 (2): 119-133). After the formation of crosslinked PEI with GA, the samples were dried in air at 70° C. for 12 hours in an oven to oxidize the aldehyde groups to carboxylic acid groups on the polymer backbone. The SEM images show that the uneven surface of the pristine GCF fibers changed to a smooth surface with a spider web-like polymer phase, thus demonstrating our approach to be a simple and effective way to coat graphite fibers in the widely used GCF electrode. FIGS. 5E-5H show a SEM-EDX spectrum (FIG. 5E) and element maps (FIGS. 5F-5H) of the PEIAA-GCF sample. The polymer phase in the PEIAA-GCF sample consisted of 90.2% (atomic) carbon, 4.5% oxygen existing in aldehyde polymer regions and carboxylic acids, and 5.1% of nitrogen in the PEI regions, while pristine GCF was mostly carbon itself as shown in FIG. 6C. Basically, the crosslinked PEI with GA does not have oxygen because the oxygens of aldehydes are removed by formation of Schiff bases with primary amines of PEI (Doan et al., RSC Advances 2015, 5 (89): 72805-72815). In this study, however, because GA caused aldehyde polymers to form with large amount of aldehyde groups, and after samples were dried at 70° C. in air, aldehydes were oxidized to carboxylic acids to improve the surface hydrophilic property for better wettability of the GCF electrode, as explained above (Hazra et al., Green Chemistry 2017, 19 (23): 5548-5552). Therefore, the oxygen in the aldehyde and carboxylic acid groups was detected by EDX and FTIR. FIGS. 7A and 7B show the contact angles with water drops for the comparison of surface characteristics of GCF electrodes before and after PEIAA modification. The contact angle of pristine GCF was significantly reduced from 112° to 45° after PEIAA modification because of the large amount of oxygen-contained functional groups that improve the GCF surface. The polymer content introduced in PEIAA-GCF was ˜1.8 wt. %, as measured by thermogravimetric analysis (FIG. 8). The weight loss of PEIAA happened below 400° C., which is similar to neat PEI and indicates that the crosslinking density of the PEIAA phase is not too high because of the formation of aldehyde polymer regions (Roy et al., ACS Applied Materials and Interfaces 2015, 7 (5): 3142-3151). Brunauer-Emmett-Teller and Barrett-Joyner-Halenda analyses were performed for pristine GCF and PEIAA-GCF samples to identify the graphite fiber surface physical property change induced by polymer modification. FIG. 9 and Table 1 demonstrate that the surface area and average pore size of the GCF became smaller and the pore volume also decreased after PEIAA modification. These results are consistent with the surface changes of the samples before and after PEIAA modification as shown in the SEM images discussed above.

TABLE 1

| | Surface area | Pore volume | Pore size |
|---|---|---|---|
| | (m²/g) | (cm³/g) | (nm) |
| Pristine GCF | 22 | 0.0455 | 0.418 |
| PEIAA-GCF | 17 | 0.0288 | 0.337 |

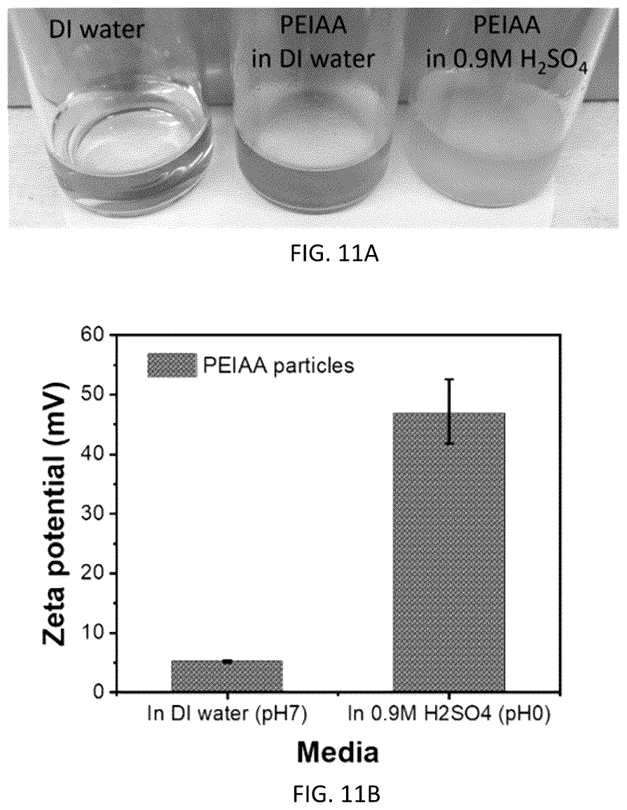

The swelling response of PEIAA was observed by immersing the sample in 0.9M H₂SO₄ solution for 5 hours. FIG. 10 shows that large volumetric swelling of the PEIAA sample occurs in the strong acidic environment. The swelling was caused by the considerable number of water molecules that were absorbed in PEIAA phase. To verify the electrostatic repulsion of PEIAA, colloidal PEIAA solutions were prepared with PEIAA particles (in DI water and 0.9M H₂SO₄ solution, respectively, and then zeta potential was measured. The digital photographs of PEIAA colloidal solutions shown in FIG. 11A clearly show that the strongly acidic condition leads to particle swelling, which leads to murky solutions as indicated by the large proportion of the light scattered by swollen particle phase while the PEIAA solution with DI water is relatively clear. FIG. 11B shows that zeta potential of the PEIAA solution with H₂SO₄ became much higher (47.2±5.4 mV) than the one with just DI water (5.2±0.22 mV). This result suggests that PEIAA particles are more stable in acidic conditions because of the strong electrostatic interactions of particle surfaces that lead to a distribution of charged polymer branches in the system.

The electrochemical performances of PEIAA-GCF and pristine GCF electrodes were evaluated in a flow cell with a traditional sulfuric vanadium electrolyte (1.5M VOSO₄ in 3.5M H₂SO₄). Testing was conducted within the voltage range of 0.8 V-1.6 V at a constant current density of 50 mA cm⁻².

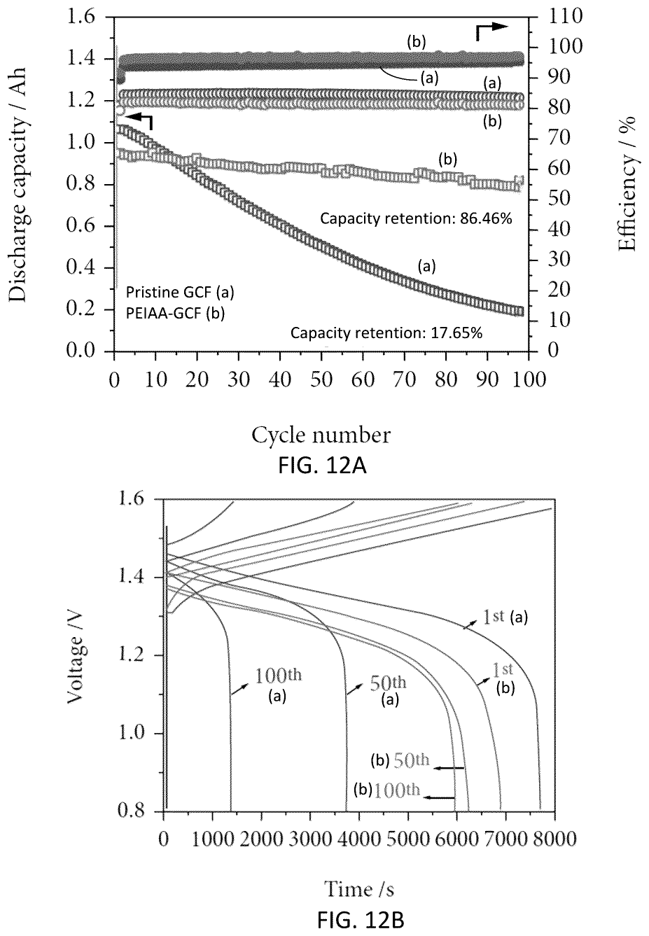

Results from flow battery cycling tests of two flow cells with a pristine GCF and a PEIAA-GCF electrode are presented in FIGS. 12A and 12B. Cycling tests were conducted to evaluate the effect of PEIAA modification on the cycling performance. Compared with the baseline GCF cell, the PEIAA-GCF cell exhibited better cell performance with much higher CE (˜2% higher throughout 100 cycles) and most notably the significantly improved capacity retention (86.46% vs. 17.65% at 100th cycle) shown in FIGS. 12A and 12B. The energy efficiency of the PEIAA-CGF cell was slightly lower than the baseline GCF cell, which may be attributable to the lower electrical conductivity and smaller surface area caused by the polymer coating.

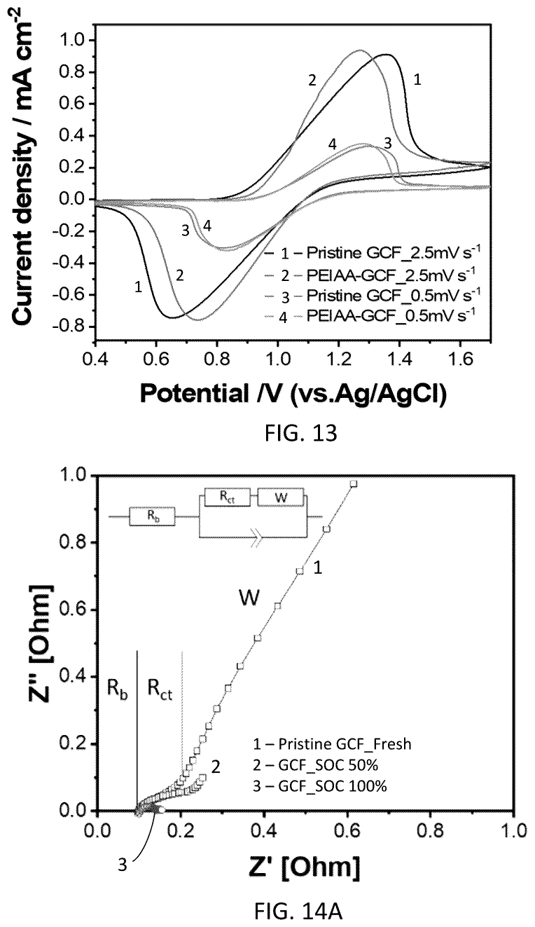

To investigate the electrochemical properties of the different GCF electrodes, the cyclic voltammetry (CV) curves were analyzed and displayed in FIG. 13. Both two different electrodes exhibited an anodic peak representing the oxidation of VO²⁺ to VO₂⁺ and a cathodic peak representing the reduction of VO²⁺ to VO₂⁺. The current density of the PEIAA-GCF in the CV test was close to that of pristine GCF at two different scan rates, which means the PEIAA modification does not interrupt the electron transferring. In addition, the smaller peak-to-peak separation of PEIAA-GCF electrode means that PEIAA modification gives rise to better chemical and electrochemical reversibility due to its better wettability leading to continuous stable reduction and reoxidation of analyte. Thus, PEIAA-GCF has no issue of electrochemical reversibility with a low barrier to electron transfer.

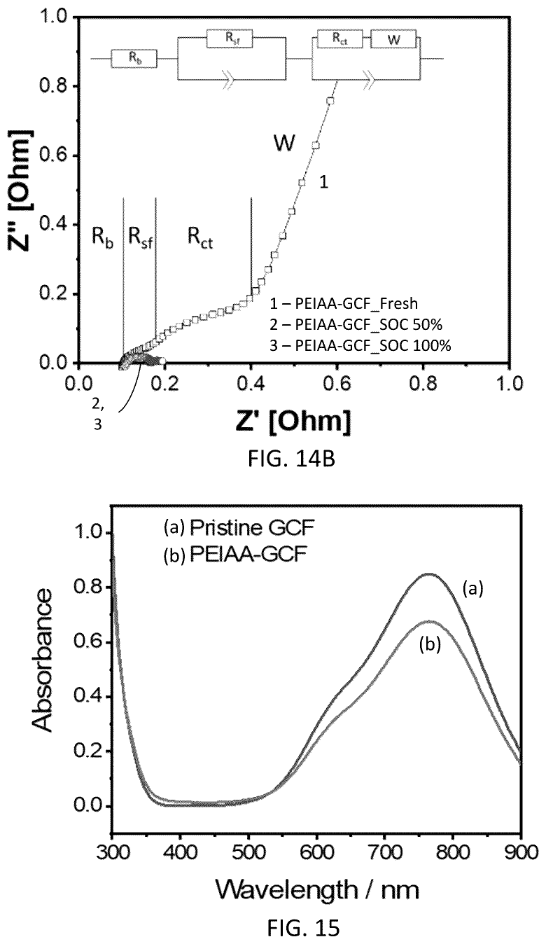

The energy efficiency of the flow cell with the PEIAA-GCF was ˜2% lower than that of the baseline cell, possibly due to an increased internal resistance of the cell from reduced electrode conductivity, which is a result from the PEIAA on the GCF coating with its smaller pore volume and surface area. The effect of the electrode modified with PEIAA interface on the positive VO²⁺/VO₂⁺ reaction was investigated by EIS measurement (FIGS. 14A and 14B; Table 2). For the fresh cells, one more semicircle (R_{sf}, surface film resistance) appeared for PEIAA-GCF cell with a larger charge transfer resistance (R_{ct}) while the pristine GCF showed only one semicircle due to the new interface in the PEIAA-GCF cell from the electrode modification. At low frequency, the PEIAA-GCF fresh cell resulted in a decrease in mass transfer resistance (W) due to the oxygen containing groups on PEIAA phase. The Nyquist plot of PEIAA-GCF cell at a SOC of 50% shows the lower charge transfer resistance due to the better wettability. However, the smaller surface area and the decreased pore volume resulting from smaller pore size and reduced electrical conductivity as mentioned earlier might cause a larger charge transfer resistance at a SOC of 100%, and consequently the lower charge-discharge capacities with a larger cell overpotential at the initial cycle. FIG. 12B shows voltage-time profiles of the GCF baseline and PEIAA-GCF cells at the 1^{st}, 50^{th}, and 100^{th} cycles. A capacity decrease of the pristine GCF cell was observed with increasing overpotential and decreasing charge-discharge time as cycling proceeded while the cycling ability of the PEIAA-GCF cell was much more stable (FIG. 12B). The poor cycling stability of the baseline cell could be attributed to both active species crossover and the subsequent increase of concentration polarization as cycling proceeds as previously reported (Li et al., ChemSusChem 2014, 7 (2): 577-584). In addition, the cycle performance tests demonstrated that PEIAA is much more stable in vanadium electrolytes over 100 cycles.

TABLE 2

| Electrodes | | R_{b} (Ω cm²) | R_{sf} (Ω cm²) | R_{cf} (Ω cm²) |
|---|---|---|---|---|
| Pristine GCF | Fresh | 0.10 | | 0.32 |
| | SOC 50% | 0.10 | | 0.29 |
| | SOC 100% | 0.10 | | 0.16 |
| PEIAA-GCF | Fresh | 0.11 | 0.23 | 0.51 |
| | SOC 50% | 0.11 | | 0.18 |
| | SOC 100% | 0.11 | | 0.19 |

To understand the mechanism of the GCF electrode modified with PEIAA on mitigation of the crossover-induced capacity decay, ICP-MS analysis of the cycled electrolytes was performed. The results revealed that the pristine GCF cell had an asymmetric valence of redox-active species in the anolyte (V³⁺) and decreasing concentration of VO²⁺ (0.3M/L, ˜22% remained at the 100^{th} cycle after discharge) in the catholyte during cycling. The imbalanced accumulation of VO₂⁺ in the positive side contributes to capacity fading and cell polarization. As a result, the amount of redox-active species VO²⁺ (V(IV)) in the positive side was significantly reduced and replaced with a high concentration of VO₂⁺ (V(V)) (FIG. 3) indicating the reaction became irreversible because of crossover of vanadium ions by possible diffusion, migration, electro-osmotic convection, and side reactions in both electrolytes given the equations below (Lee et al., J. of Electrochem. Energy Conversion and Storage 2020, 17 (1): 011008). Diffusion of vanadium ions through the membrane happens in the same direction regardless of charging and discharging. On the other hand, the direction of migration and electro-osmotic convection is affected by charging or discharging. Different diffusion rates of vanadium ions can cause capacity fading due to a disparity between the state of charge of the anolyte and catholyte. Consequently, there is an accumulation of VO₂⁺ in the catholyte as cycling proceeds. In comparison, the PEIAA-GCF cell retained almost the same concentration of VO²⁺ (1.45 M; ˜ 99.4% remained at the 100^{th} cycle) in the catholyte, leading to symmetric valence of redox-active species with a negligible amount of VO₂⁺ even after the 100^{th} discharge compared to the pristine cell. Because large amounts of amino groups in an abundance of PEI branches are protonated in strongly acidic conditions, strong positive charges prevent vanadium ion permeation by electro-charge repulsion. Besides, the significant expansion of PEIAA films with carboxylic acids help limit undesired transport of vanadium ions and enhance electrochemical performance.

To verify the effect of the PEIAA interface on reducing vanadium crossover, the 3.5M H₂SO₄ solution was coupled with the catholyte (1.5M V⁴⁺ in 3.5 M H₂SO₄ solution) and pumped through the cell where they were separated by Nafion® 115 with pristine GCF or PEIAA-GCF electrodes for 5 days. UV-vis spectra were recorded for the concentrations of V⁴⁺ ions in H₂SO₄ solutions. The absorbance spectra at 765 nm of two samples revealed that the PEIAA interface led to ˜25% lower V⁴⁺ crossover, as displayed in FIG. 15. Under no externally applied electric field, the results confirmed that the PEIAA interface on GCF slows crossover of VO₂²⁺ ions via diffusion and convection. Along with the PEIAA-GCF electrode's ability to delay crossover, good wettability with aqueous electrolytes containing hydrated cationic vanadium ions with water molecules also is helpful to maintain good cycling stability. During charge and discharge processes, it is possible that vanadium ions coordinate with water molecules, with one oxygen atom coming from sulfate and one carboxyl oxygen atom coming from amino and carboxylic acid in the PEIAA as previous studies suggest (Thompson et al., Coordination Chemistry Reviews 2001, 219-221:1033-1053; Deng et al., Polyhedron 2019, 159:375-381).

Therefore, hyper branched PEIAA networks with carboxylic acids present in GPI between the surfaces of the positive electrode and the Nation® membrane are effective in preventing vanadium ion crossover through the mechanisms of electrical repulsion from the protonated amines in acidic condition, physical hindrance from swollen PEIAA films in strong acidic electrolytes to prevent undesired vanadium crossover, and improved wettability with possible coordination chemistry of the amino and carboxylic acid functionality of PEIAA to stabilize the oxidation state of VO²⁺ and VO₂⁺ species.

Negative side:

VO²⁺+V²⁺+2H+→2V³⁺+H₂O (1)

VO²⁺+2V²⁺+4H⁺→+3V³⁺+2H₂O (2)

Positive side:

V³⁺+VO₂⁺→2VO²⁺ (3)

V²⁺+VO²⁺+2H⁺→2V³⁺+H₂O (4)

<Possible Side Reactions in Electrolytes with Vanadium Ions Moving from Opposite Sides>

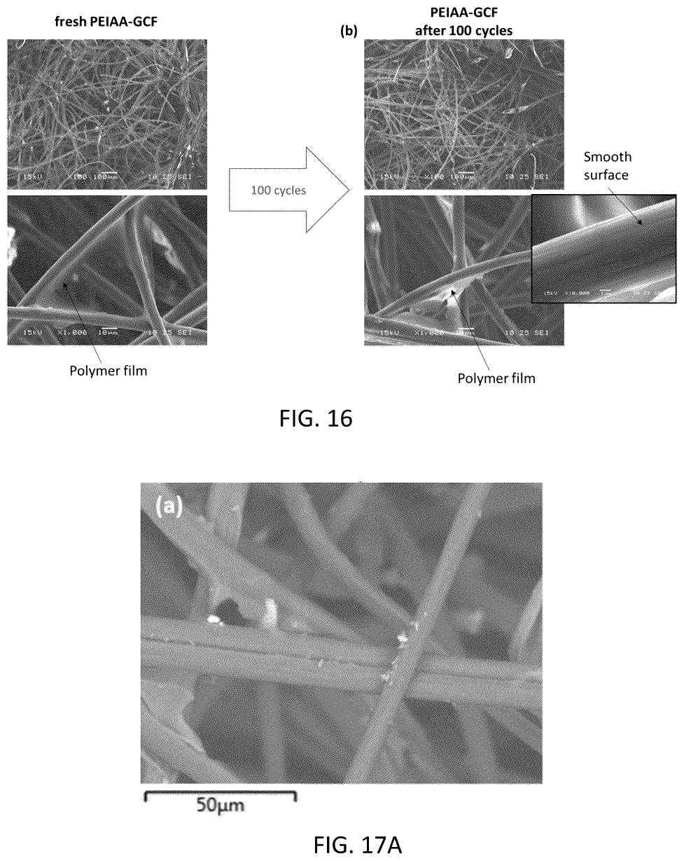

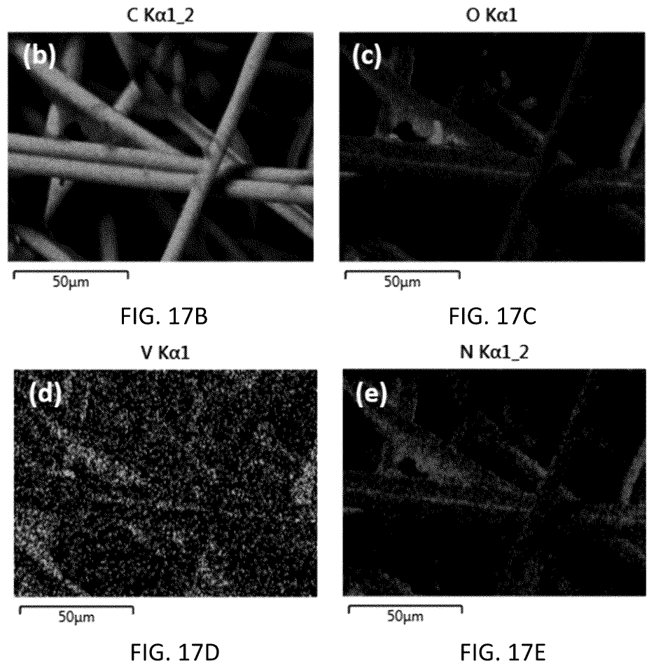

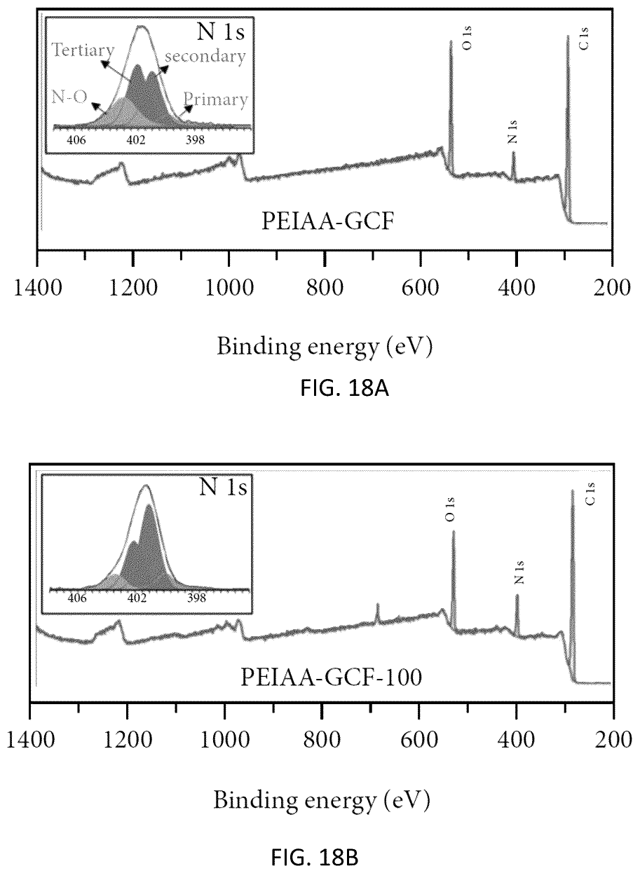

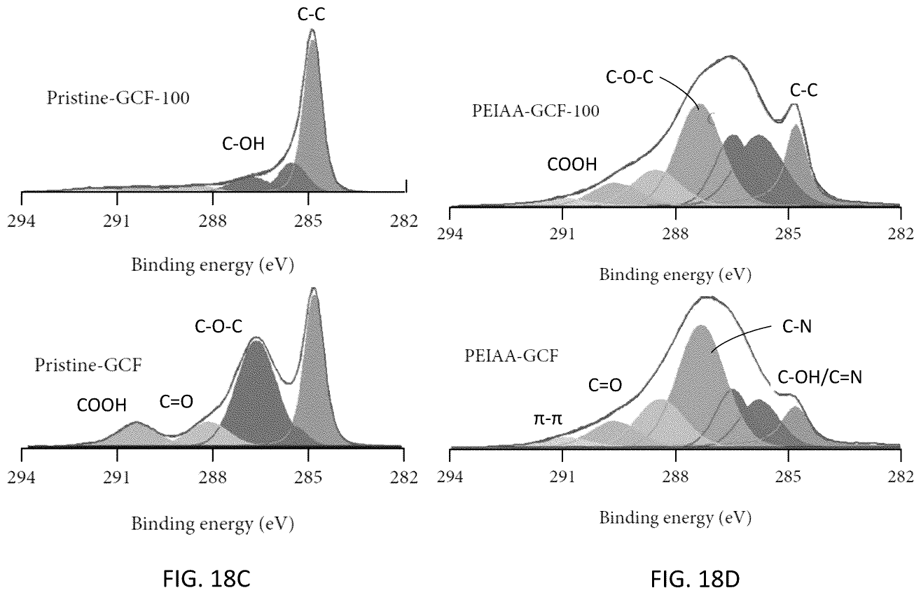

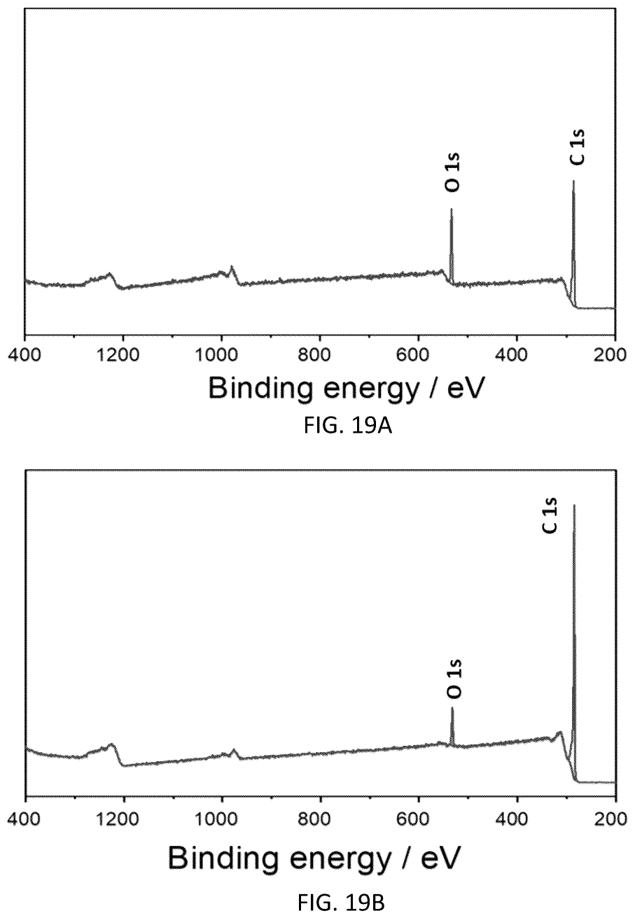

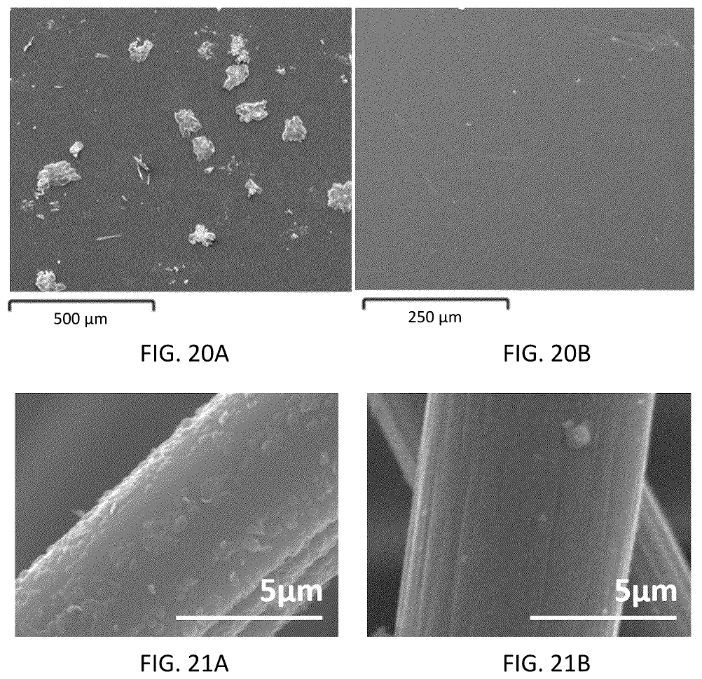

The cycled electrodes and electrolytes were further analyzed using SEM, EDX, XPS, and ¹H-NMR. FIGS. 16 and 17A-17E show the smooth surface of carbon strings and the surviving polymer films detected with a EDX-nitrogen map after 100 cycles in vanadium electrolyte. Based on wide-scan XPS spectra, it is notable that N 1s spectra appear only in PEIAA-GCF samples due to the tertiary amino groups of PEI while pristine GCF has no N 1s signal, as shown in FIGS. 18A-18D and FIGS. 19A and 19B. FIGS. 20A and 20B are SEM images of the Nation® 115 membranes in the GCF baseline (FIG. 20A) and PEIAA-GCF (FIG. 20B) cells after 100 cycles. The images show extensive precipitation on the GCF baseline membrane, while the membrane of the PEIAA-GCF cell had a clean surface. These results that the polymer modification reduces or eliminates precipitation, which can cause loss of redox-active species, reduced proton conductivity, and increased cell polarization during cycling.

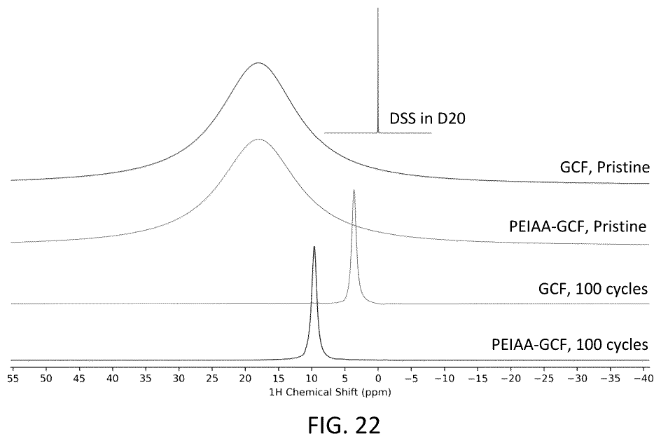

XPS spectra of the PEIAA-GCF samples before and after 100 cycles also provided evidence that the crosslinked PEIAA was chemically stable in the strong acidic solution and oxidative environment of the VO₂⁺ ions in the charged catholyte. The nitrogen binding energies for the primary, secondary and tertiary amine peaks detected between 399 eV and 401.7 eV³¹ were retained after 100 cycles, as shown in FIGS. 18A and 18B. Since PEI chains are crosslinked with GA and the aldehyde groups are oxidized to carboxylic acid groups, C═N and COOH bondings were also detected at 285.7 eV and 288.5 eV, respectively. In the case of the pristine GCF sample before the cell test, there also were several peaks of C 1s binding energies corresponding to C—OH, C—O—C, C═O, and COOH frequencies at 286.11, 286.72, 287.32 and 288.14, respectively. However, the intensities of these peaks were reduced significantly after 100 cycles, as shown in FIG. 18C. Thus, organics containing oxygen atoms on the GCF surface were removed or decomposed in the strong acidic electrolytes during long-term cycling. This result may correspond to the surface change from rough to relatively smooth after cycling, as shown in FIGS. 21A and 21B. In contrast, all C 1s binding energy peaks for PEIAA-GCF that underwent the same testing conditions, as shown in FIG. 18D, also show that no polymer (PEIAA) dissolution occurred in the catholytes over 100 cycles, as shown in FIG. 22. Thus, the chemical robustness of GPI consisting of the crosslinked PEIAA with carboxylic acids contributes to the long-term stability of vanadium redox flow battery cells.

In conclusion, a simple modification method was used to introduce a GPI to a chemically stable crosslinked PEIAA to the surface of a GCF acting as the positive electrode in a VRB. The PEIAA-GPI electrode demonstrated a significant blocking effect in preventing active vanadium species from crossover, thus providing more stable cycling performance. In contrast, severe imbalanced crossover and asymmetrical valence of active-species vanadium ions were observed in a cell using pristine GCF electrodes. The PEIAA-GPI also reduced precipitation of vanadium compounds, which form at high SOC and block the membrane pores. The positive effect of the PEIAA GPI on cell cycling is attributed to the multifunctional mechanisms of electro-repulsion, physical hinderance from swollen PEIAA films to limit the vanadium crossover, and coordination chemistry of the chemically stable polymer interface with good wettability in strong acidic condition to maintain the concentrations of the vanadium active species stable in their respective half-cell reservoirs.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. An electrode, comprising:
a conductive substrate; and
a crosslinked branched polymer disposed on at least a portion of a surface of the conductive substrate, the crosslinked branched polymer comprising a plurality of tertiary amino groups and a plurality of carboxylic acid groups, carbonyl groups, hydroxyl groups, or any combination thereof.

2. The electrode of claim 1, wherein the conductive substrate comprises carbon felt, carbon paper, or carbon cloth.

3. The electrode of claim 2, wherein the crosslinked branched polymer coats individual carbon fibers on a surface of the conductive substrate.

4. The electrode of claim 1, wherein the crosslinked branched polymer comprises a branched polyalkylene imine polymer crosslinked with a crosslinker comprising at least two oxygen-containing reactive groups, where the at least two oxygen-containing reactive groups are C(O) groups, epoxy groups, —COOH groups, or any combination thereof.

5. The electrode of claim 4, wherein the branched polyalkylene imine polymer comprises branched polyethyleneimine, branched polypropyleneimine, branched poly(ethyleneimine-co-propyleneimine), or any combination thereof.

6. The electrode of claim 4, wherein the branched polyalkylene imine polymer has a weight average molecular weight M_{w} of 20 kDa to 30 kDa by light scattering, a number average molecular weight Mₙ of 8 kDa to 12 kDa by gel permeation chromatography, or both.

7. The electrode of claim 4, wherein the crosslinker comprises glutaraldehyde, glyoxal, malonaldehyde, succinaldehyde, adipaldehyde, methylglyoxal, glyoxal, biacetyl, cyclopentan-1,2-dione, oxalic acid, tartaric acid, citric acid, malic acid, succinic acid, 1,4-butanediol diglycidyl ether, ethylene glycol diglycidyl ether, poly(ethylene glycol) diglycidyl ether, glycerol dimethacrylate, glycerol dimethacrylate, poly(ethylene glycol) dimethacrylate, ethylene glycol dimethacrylate, 2-hydroxylethyl methacrylate, vinyl methacrylate, allyl methacrylate, 1,4-phenylene dimethacrylate, 1,4-butanediol dimethacrylate, carboxybetaine dimethacrylate, poly(carboxybetaine methacrylate), propylene dimethacrylate, poly(propylene glycol) dimethacrylate, or any combination thereof.

8. The electrode of claim 4, wherein the crosslinked polymer comprises branched polyethyleneimine crosslinked with glutaraldehyde.

9. The electrode of claim 8, wherein the crosslinked branched polymer comprises the branched polyalkylene imine polymer and the glutaraldehyde in a weight ratio of from 3:1 to 7:1.

10. The electrode of claim 1, wherein the crosslinked branched polymer is disposed on 10% to 30% of a surface area of the conductive substrate.

11. The electrode of claim 1, wherein:
the conductive substrate comprises carbon felt; and
the crosslinked branched polymer comprises branched polyethyleneimine crosslinked with glutaraldehyde.

12. A battery, comprising:
a first electrode comprising a conductive substrate and a crosslinked branched polymer disposed on a surface of the conductive substrate, the crosslinked branched polymer comprising a plurality of tertiary amino groups and a plurality of carboxylic acid groups;
a second electrode;
an electrolyte; and
a membrane between the first electrode and the second electrode, wherein the crosslinked branched polymer on the surface of the conductive substrate is between the conductive substrate and the membrane.

13. The battery of claim 12, wherein the second electrode comprises a conductive substrate and a crosslinked branched polymer disposed on a surface of the conductive substrate, the crosslinked branched polymer comprising a plurality of tertiary amino groups and a plurality of carboxylic acid groups.

14. The battery of claim 12, wherein the battery is a redox flow battery.

15. The battery of claim 12, wherein the battery is a vanadium redox flow battery.

16. The battery of claim 12, wherein:
the conductive substrate comprises carbon felt; and
the crosslinked branched polymer comprises branched polyethyleneimine crosslinked with glutaraldehyde.

17. A method of making an electrode according to claim 1, the method comprising:
immersing a portion of a conductive substrate in a solution comprising a branched polymer comprising a plurality of tertiary amino groups;
subsequently immersing the portion of the conductive substrate in a solution comprising a crosslinker comprising at least two oxygen-containing reactive groups, where the at least two oxygen-containing reactive groups are C(O) groups, epoxy groups, —COOH groups, or any combination thereof, whereby the crosslinker crosslinks the branched polymer to provide a crosslinked branched polymer on a surface of the portion of the conductive substrate; and
if the crosslinker retains one or more C(O) or epoxy groups after crosslinking the branched polymer, subsequently heating the crosslinked branched polymer on the surface of the portion of the conductive substrate to convert at least some of the one or more C(O) or epoxy groups of the crosslinker to carboxylic acid groups.

18. The method of claim 17 wherein heating the crosslinked branched polymer comprises heating at a temperature of at least 70° C. for at least 3 hours under vacuum or heating at a temperature of at least 70° C. for at least 10 hours in an oxygen-containing atmosphere.

19. The method of claim 17, wherein:
the branched polymer comprises a polyalkylene imine; and
the crosslinker comprises a dialdehyde.

20. The method of claim 17, wherein:
the branched polymer comprises polyethyleneimine; and
the crosslinker comprises glutaraldehyde.
